(19) United States
(12) Patent Application Publication
(10) Pub. No.: US 2024/0140161 A1
(43) Pub. Date: May 2, 2024

(54) AERODYNAMIC ELECTRIC VEHICLE THERMAL MANAGEMENT SYSTEM WITH INDEPENDENT DRIVETRAIN LOOP

(71) Applicant: APTERA MOTORS CORP., San Diego, CA (US)

(72) Inventors: Daniel MORRIS, San Marcos, CA (US); Steve FAMBRO, San Diego, CA (US); Eric BYERS, Oceanside, CA (US); Chris ANTHONY, San Diego, CA (US); Jason HILL, Costa Mesa, CA (US); John KLOPP, III, Encinitas, CA (US)

(73) Assignee: APTERA MOTORS CORP., San Diego, CA (US)

(21) Appl. No.: 18/051,859

(22) Filed: Nov. 1, 2022

(51) Int. Cl. B60H 1/00

(52) U.S. Cl. CPC B60H 1/00028; B60H 1/00278; B60H 1/00385; B60H 2001/00092; B60H 2001/00107

(57) ABSTRACT

A thermal management system for an electric vehicle having a drivetrain flow path coupling one or more motors and one or more inverters to an aerodynamic heat exchanger comprising one or more body panels disposed along an outer surface of the vehicle, the aerodynamic heat exchanger having one or more fluidic chambers or micro-channels. The drive flow path is decoupled from the vehicle's chiller and/or refrigeration cycle under all operating conditions. The drivetrain may be further characterized by the one or more motors being disposed proximate one or more wheels of the vehicle, such as within the wheel skirt or cowling, to capitalize on passive or free cooling via ambient airflow about the wheel. The thermal management system may further include a refrigeration cycle wherein the cabin and the battery pack are provided cooling in a parallel configuration or in a serial configuration.

### CROSS REFERENCE TO RELATED APPLICATIONS

This application incorporates by reference the entire contents of the following Applicant's co-pending applications of Aerodynamic Heat Exchanger For A Vehicle, Ser. No. 17/930,473, filed Sep. 8, 2022, and Supplemental Aerodynamic Heat Exchanger For A Vehicle, Ser. No. 17/931,239, filed Sep. 12, 2022.

### TECHNICAL FIELD

The present disclosure relates generally to a heating, ventilating, and air conditioning (HVAC) apparatus, system, and method, and in particular to an electric or solar-electric vehicle having an HVAC apparatus, system, and method for efficient thermal management.

### BACKGROUND

Thermal management systems are in widespread use in consumer, commercial, industrial, and other sectors, such as heating and cooling enclosed spaces, like buildings or vehicles. Design considerations of conventional thermal management systems have expanded to include focus on energy conservation, conversion, recovery, and successful adaptation to new energy sources. Also, environmental guidelines and regulations drive the improvement of energy efficiency of such systems, to combat the effects of a warming planet, such as thermal, air, and water pollution. A conventional thermal management system fundamentally operates on the thermodynamic principle that heat moves from a hotter object to a colder object, where one or more heat exchangers incorporate structures that form separate hot and cold regions. In this way, heat exchangers are designed to spontaneously move heat, or thermal energy, from the hotter region to the colder region with no external heat or work interactions, which implies that the transfer of heat occurs passively, or automatically.

But capitalizing on this “free” heat transfer as a way to decrease energy needed thereby improving efficiency remains a challenge to implement in thermal management systems, because almost always some amount of energy is necessary to cause heat to transfer. Therefore, energy-consuming system components are relied upon. For example, a fan placed adjacent a radiator actively rejects heat—with the penalty of energy consumed to power the fan. Similarly, a chiller relies on the phase change of a refrigerant to pull heat out of a system component to keep it from overheating—at the cost of powering a compressor to power the refrigeration cycle. Furthermore, a radiator placed at the front of a moving vehicle capitalizes on the “free” air rushing through it to passively reject heat, but even this arrangement comes at the added cost of increasing the vehicles overall aerodynamic drag, thereby increasing the energy required to move the motor(s).

Electric vehicles require the removal of heat from not only the passenger cabin, but also the batteries, the electric motors, and other electric components, like inverters. These entities may be referred to as demand systems, i.e., systems that demand thermal management in different quantities and at different times. Conventional batteries and motors generate enormous amounts of heat that needs to be rejected from the vehicle to keep all manner of components from overheating and/or burning up. Such heat rejection, i.e., cooling, similarly consumes large amounts of energy to effectuate. Therefore, it is important to efficiently manage temperatures of the electric motors, the various electrical components like inverters, and the battery.

Because each demand system may have a different demand profile as a function of time, one conventional solution employs separate cooling systems to adjust the temperatures of the motor, the electrical components, the battery, and the passenger cabin, but problems exist in that there is limited space in a moving vehicle to accommodate multiple dedicated systems and such a system consumes more energy. Other conventional thermal management design solutions employ complex systems that employ a single source of cooling, but by a similar token, these solutions consume more energy because they employ active devices—such as the aforementioned fan and/or chiller.

While a variety of different techniques and system configurations have been used for vehicle thermal management systems, such systems continue to suffer from inefficiencies in the form of high energy consumption, increased aerodynamic drag of the vehicle, high physical space requirements, all of which in turn negatively affects fuel economy, overall performance, and range of the electric vehicle. Accordingly, what is needed is a thermal management system that overcomes these disadvantages.

### SUMMARY

The present invention provides a functionally, economically, and aesthetically advantageous vehicular thermal management system that employs an aerodynamic, lightweight heat exchanger including effective and efficient heat transfer.

An object of the present invention is to provide a motor drive train system that is decoupled from the chiller under all operating conditions, thereby improving energy efficiency of the vehicle.

A further object of the present invention is to provide a motor drive train system that rejects at least a portion of heat to the ambient environment passively, i.e., “free cooling”, by locating the motor(s) at least partially within the ambient flow field, thereby improving energy efficiency of the vehicle.

A further object of the present invention is to provide a vehicle having a low drag coefficient that substantially reduces the power required by the one or more vehicle motors, thereby decreasing the cooling requirement of the same.

A further object of the present invention is to provide a motor drive train system that rejects heat to one or more aerodynamic heat exchangers, the aerodynamic heat exchanger eliminating, or substantially eliminating, flow separation occurring over the heat exchanger, thereby decreasing the drag of the heat exchanger when drag factors are considered either in isolation or in the context of the overall vehicle. It is a further object of the present invention to reduce flow separation and drag in totum, whereby the vehicle performance may be increased.

A further object of the present invention is to provide an aerodynamic heat exchanger that eliminates, or substantially eliminates, the heat exchanger's contribution to the pressure drag and/or friction drag of the vehicle, whether considered in isolation or in the context of the overall vehicle.

A further object of the present invention is to reduce or eliminate protuberances that ‘trip’ or otherwise induce turbulence of the airflow over the vehicle, including airflow over the heat exchanger.

A further object of the present invention is to provide a thermal management system having one or more aerodynamic heat exchangers formed integrally with a body panel, thereby reducing weight and improving vehicle performance.

Other desirable features and characteristics will become apparent from the subsequent detailed description, the drawings, the abstract, and the claims, when considered in view of this summary.

### DESCRIPTION OF THE DRAWINGS

Non-limiting and non-exhaustive embodiments of the present disclosure are described with reference to the following drawings. In the drawings, like numerals describe like components throughout the several views.

For a better understanding of the present disclosure, reference will be made to the following Detailed Description, which is to be read in association with the accompanying drawings, which are incorporated in and constitute a part of this specification, show certain aspects of the subject matter disclosed herein and, together with the description, help explain some of the principles associated with the disclosed implementations, wherein:

FIG. 1 illustrates a front, top, right-side, exploded, perspective view of an aerodynamic vehicle including an aerodynamic heat exchanger, according to an embodiment of the present invention;

FIG. 2 illustrates a front, bottom, right-side, perspective view of an aerodynamic vehicle including an aerodynamic heat exchanger, according to an embodiment of the present invention;

FIG. 3 illustrates a front view of an aerodynamic vehicle including an aerodynamic heat exchanger, according to an embodiment of the present invention;

FIG. 4 illustrates a bottom view of an aerodynamic vehicle including an aerodynamic heat exchanger, according to an embodiment of the present invention;

FIG. 5 illustrates a right-side view of an aerodynamic vehicle including an aerodynamic heat exchanger, according to an embodiment of the present invention;

FIG. 6A illustrates a partially exploded perspective view of a wheel assembly, according to an embodiment of the present invention;

FIG. 6B illustrates an enlarged view taken from FIG. 6A of a wheel assembly including a cooling jacket, according to an embodiment of the present invention;

FIG. 7 illustrates a bottom, interior view of an inner chamber portion of an aerodynamic heat exchanger, according to an embodiment of the present invention;

FIG. 8 illustrates a bottom view of an outer chamber portion of an aerodynamic heat exchanger, which may be a body panel of the aerodynamic vehicle, according to an embodiment of the present invention;

FIG. 9 illustrates a cross-sectional view taken along the line A-A in FIG. 7, which shows aspects of a second chamber of an aerodynamic heat exchanger, according to an embodiment of the present invention;

FIG. 10 illustrates a right-side view of an aerodynamic vehicle including an aerodynamic heat exchanger showing streamlines along the center thereof;

FIG. 11 illustrates a rear, top, right-side perspective view of an aerodynamic vehicle including an aerodynamic heat exchanger showing flow separation regions along the body thereof;

FIG. 12 illustrates a schematic of an exemplary thermal management system, according to an embodiment of the present invention;

FIG. 13 illustrates a schematic view of an exemplary water-side thermal management system, having a drive flow path decoupled from the chiller and where the chiller is ON, according to an embodiment of the present invention;

FIG. 14 illustrates a schematic view of an exemplary water-side thermal management system, having a drive flow path decoupled from the chiller, wherein the chiller is OFF, according to an embodiment of the present invention;

FIG. 15 illustrates a schematic view of an exemplary water-side thermal management system, having a drive flow path decoupled from the chiller, wherein the cabin and battery pack demand systems are serially disposed with respect to the chiller, according to an embodiment of the present invention;

FIG. 16 is a perspective view illustrating the flow field formed around a conventional vehicle characterized by numerous flow separations, wherein:

FIG. 17A illustrates an enlarged, cross-sectional, right-side view of flow through the front-end grille and radiator, with flow separation, body drag, and engine cooling drag thereof;

FIG. 17B illustrates an enlarged, cross-sectional, right-side view of flow at the intersection of the hood and the windshield, with flow separation, body drag, and ventilation drag thereof;

FIG. 17C illustrates an enlarged, perspective view of flow over the side of the windshield along the driver's-side door, with flow separation and body drag thereof;

FIG. 17D illustrates an enlarged, cross-sectional, right-side, view of flow though the front-end grille and fender spoiler, with body drag, protuberance drag, and engine cooling drag thereof, and with flow separation occurring underneath the vehicle;

FIG. 17E illustrates an enlarged, cross-sectional, top view of flow around the driver's-side extending over the wheel, with flow separation, body drag, and protuberance drag thereof;

FIG. 17F illustrates an enlarged, cross-sectional, top view of flow around the driver's side extending over the front and rear doors of the vehicle, with flow separation and body drag thereof;

FIG. 18A illustrates a cross-sectional view of the effect of viscosity on an exemplary body in a uniform velocity fluid field, with separated flow resulting from an adverse pressure gradient;

FIG. 18B illustrates flow profiles of positions S₁, S₂, and S₃ taken from FIG. 18A; and

FIG. 18C illustrates an adverse pressure gradient, in accordance with FIGS. 18A and 18B.

### DETAILED DESCRIPTION

Non-limiting embodiments of the invention will be described below with reference to the accompanying drawings, wherein like reference numerals represent like elements throughout. While the invention has been described in detail with respect to the preferred embodiments thereof, it will be appreciated that upon reading and understanding of the foregoing, certain variations to the preferred embodiments will become apparent, which variations are nonetheless within the spirit and scope of the invention. The drawings featured in the figures are provided for the purposes of illustrating some embodiments of the invention and are not to be considered as limitation thereto.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, and/or operably connected, although not necessarily directly, and not necessarily mechanically. “Thermally coupled” refers to two or more elements adapted for transferring, and/or operably transferring, heat between the elements, although not necessarily directly. The term “coupled” may also, but not necessarily, be defined as thermally coupled.

Reference throughout this document to “some embodiments”, “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are provided for the purposes of illustrating some embodiments of the present disclosure, and are not to be considered as a limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

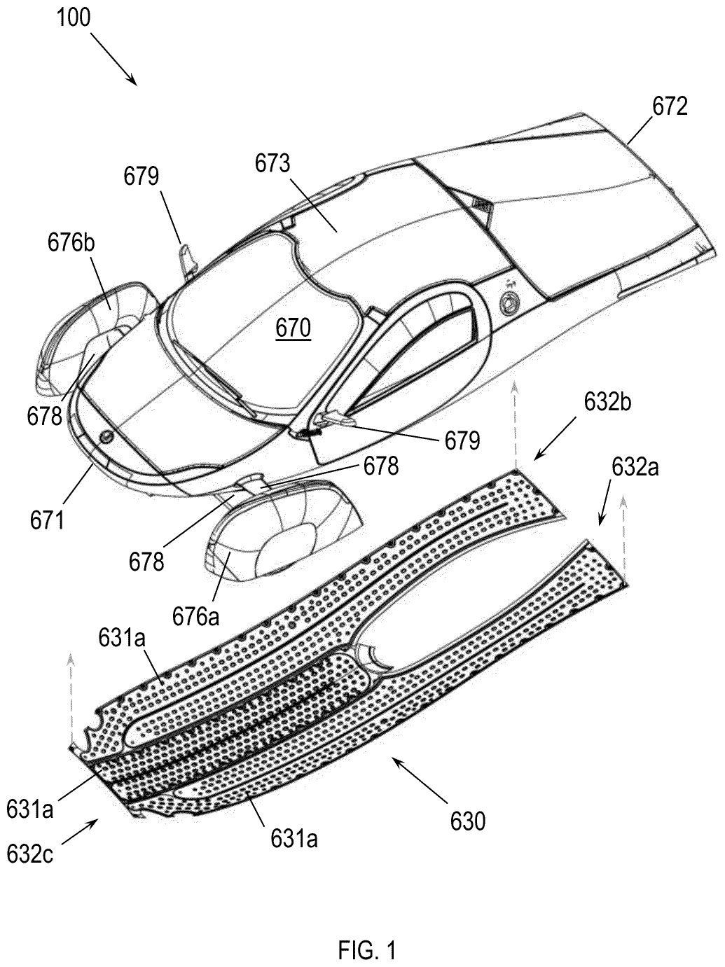

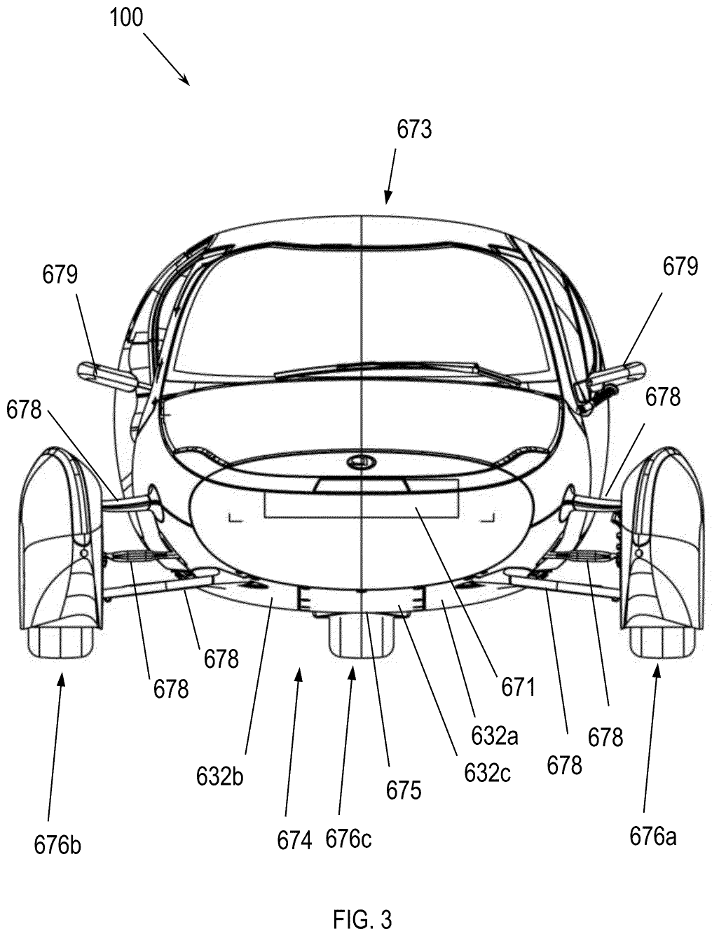

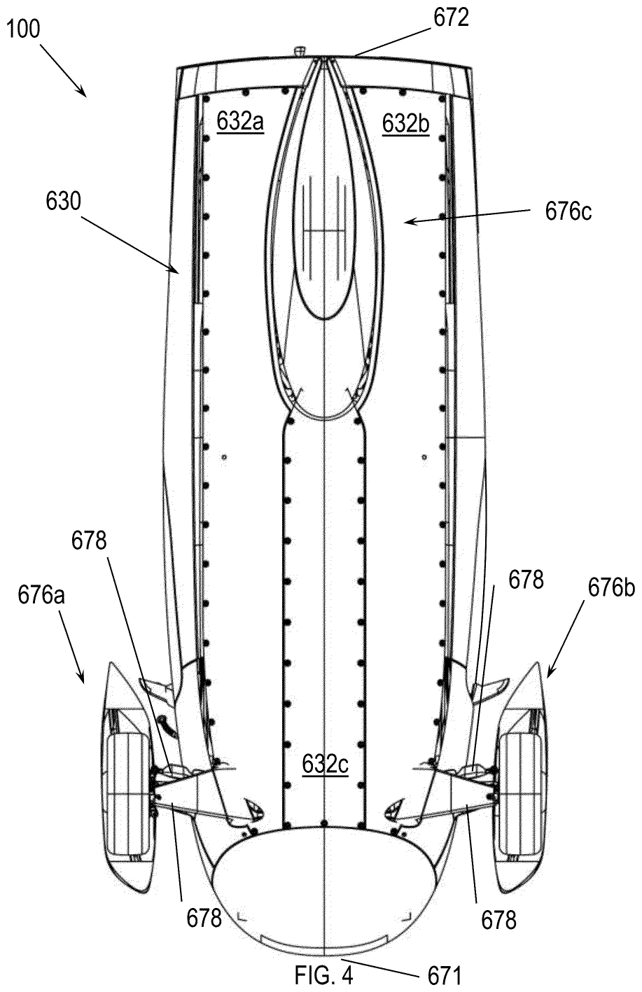

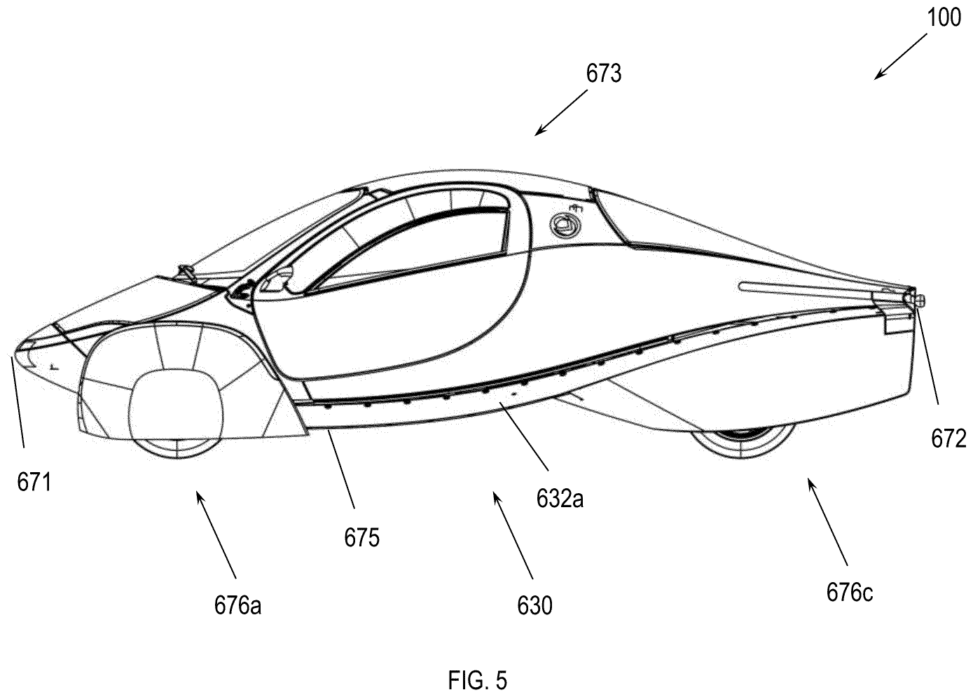

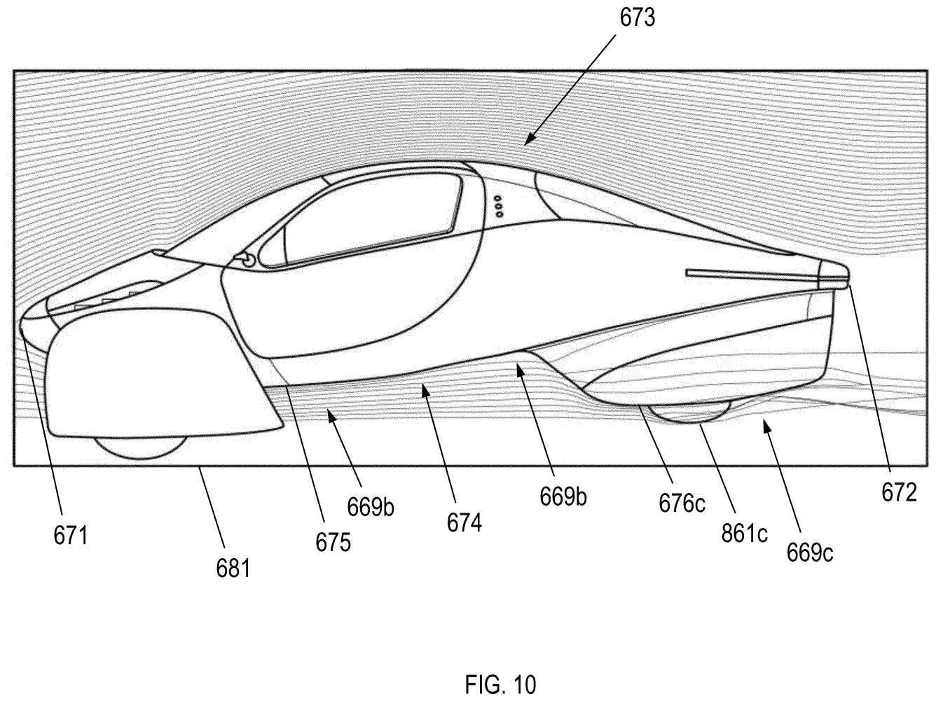

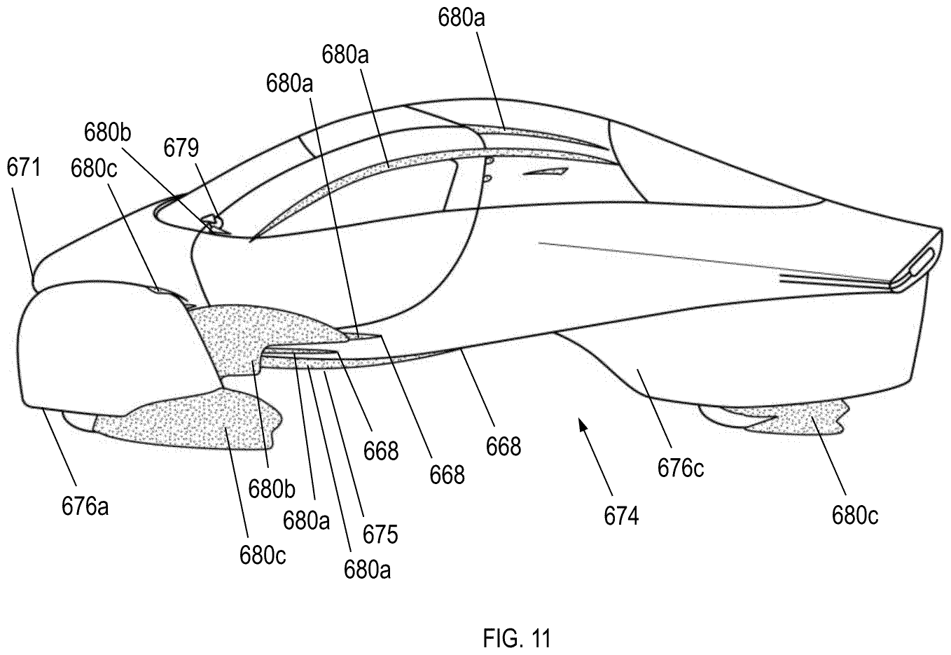

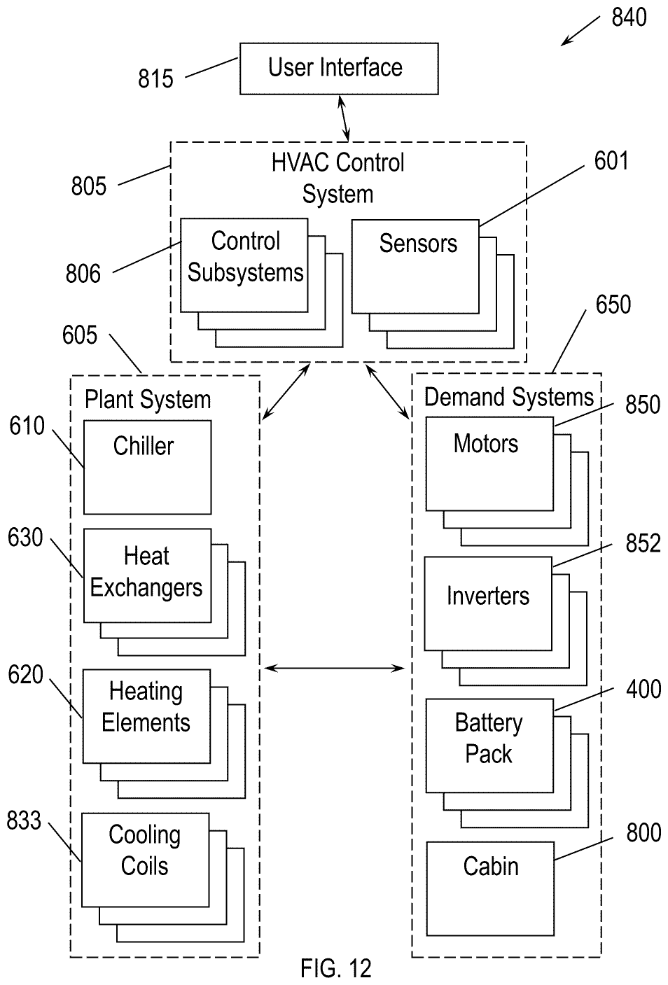

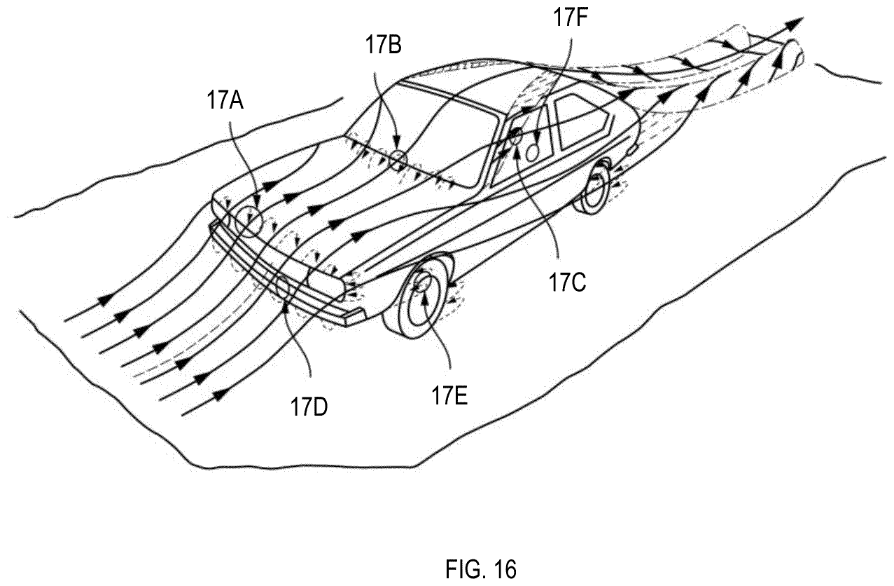

Referring to FIGS. 1-18C, a thermal management system generally designated as reference element 840 is useful for heating, cooling, ventilating, and otherwise transferring heat within or away from an aerodynamic vehicle 100. FIGS. 1-9 refer to embodiments of certain structural aspects of the thermal management system 840, in particular drivetrain apparatus, system, and method 870, as well as the one or more aerodynamic heat exchangers 630 that provide heat rejection for aerodynamic vehicle 100, both according to the present invention. FIGS. 10 and 11 refer to flow field effects of aerodynamic vehicle 100 when in motion, also according to the present invention. FIG. 12-15 refer to various schematics of exemplary thermal management system 840 architecture, additionally according to the present invention, and FIGS. 16, 17A-17F, and 18A-18C refer to various aerodynamic features and/or parameters of the embodiments disclosed herein.

In accordance with the schematic shown in FIG. 12, at a high level, a thermal management system 840 configured for use in a vehicle 100 comprises a user interface 815, an HVAC control system 805, and a plant system 605, wherein thermal management system 840 may be configured to provide the heating, cooling, ventilating, and otherwise transferring heat according to the demands of demand systems 650. Demand systems 650 may include motors 850 and inverters 852 associated with a drivetrain, battery pack 400, and cabin 800 loads from passengers, solar gain, etc. Concerning the drivetrain, components other than motors 850 and inverters 852 may require thermal management, such as electronic components. Demand systems 650 are categorized in this manner for ease of illustration, and shall not be construed as limited thereto. Furthermore, thermal management system 840 of aerodynamic vehicle 100 may employ one or more aerodynamic heat exchangers 630. A heat exchanger 630 such as this may be formed as one or more body panels disposed along an outer surface of aerodynamic vehicle 100 to provide heat rejection of demand systems 650 via heat transfer communication with various other subsystems of plant system 605. Aerodynamic heat exchanger 630 provides a functionally, economically, and aesthetically advantageous design adapted for: providing effective heat transfer under all operating conditions of vehicle 100, such as sufficient heat rejection capacity to meet the needs of demand system 650; providing highly-efficient, heat transfer through passive convective and radiative heat transfer to the ambient environment over all, or at least most, of the vehicle's operating conditions; providing a supplemental heat exchanger arrangement and/or system that contributes negligible drag to the vehicle during operation and for conditions where the primary heat exchange mode exhibits reduced or otherwise insufficient heat rejection capacity; and providing substantially reduced or negligible contribution to the aerodynamic drag, i.e., a substantially reduced or negligible external drag 661 contributed by the aerodynamic heat exchanger, either in isolation or in combination with other components of vehicle 100. As should be appreciated, aerodynamic heat exchanger 630 comprises one or more fluidic chambers, e.g., 632a-c as in FIG. 1, which are described in the context of one or more body panels disposed along the underside 674, or undercarriage 674, of the vehicle 100, but may alternatively comprise one or more body panels disposed on any surface of the exterior, including hood panel, roof panel, trunk panel, front-side panel, mid-side panel, back-side panel, door panel, front wheel cover, and/or rear-wheel skirt. However, in the preferred embodiment, aerodynamic heat exchanger 630 is disposed along the underside to avoid direct exposure to the sun.

FIGS. 1-11 illustrate certain aspects of the thermal management system 840 according to the present invention. First, design cooling load ranges have been estimated to be from about 1 kW to about 3 kW, e.g., demand systems 650 as in FIG. 12. Cooling capacity is calculated based upon summer high temperature conditions (e.g., 99.5% design condition for hottest operating climate zone) which necessitates, e.g., cabin cooling demand, e.g., passenger sets cabin 800 temperature to 70° F. during a design day in Washington, D.C. of 95° F./78° F., dry bulb temperature/wet bulb temperature. Second, concerning the capacity of the aerodynamic heat exchanger 630 along the exteriorly-exposed surface, 20 kW of heat rejection has been estimated, corresponding to a capacity when the aerodynamic vehicle 100 has reached sufficient speed, above about 10 mph to about 15 mph.

Third, and a focus of the instant disclosure, a drivetrain apparatus, system, and method 870 is provided, which provides the necessary heat rejection of the motors 850 and inverters 852, as well as other drive train components, without needing the chiller 610, under all driving conditions. While conventional designs require that the drivetrain be cooled by the chiller at least under some conditions, if not under all conditions, the present invention saves energy by safely and adequately dissipating heat without thermal coupling of a chiller 610. As will be described in detail, this advantageous design is feasible for at least several reasons: (i) the unique aerodynamic shape of the vehicle 100 reduces drag, which significantly lowers the instantaneous power required by the one or more motors 850, thereby decreasing heat output; (ii) the motors 850 are located proximate the vehicle 100's tires, and therefore benefit from passive, “free” convective heat transfer to dissipate at least a portion of the heat generated by motors 850; (iii) a drivetrain system 870 may employ one or more aerodynamic heat exchangers 630 to efficiently remove heat actively; (iv) the drivetrain system 870 only requires a pump, and not additional energy consuming devices, such as fans; and (v) the efficiency of the motor 850 is increased by a direct-line drive configuration.

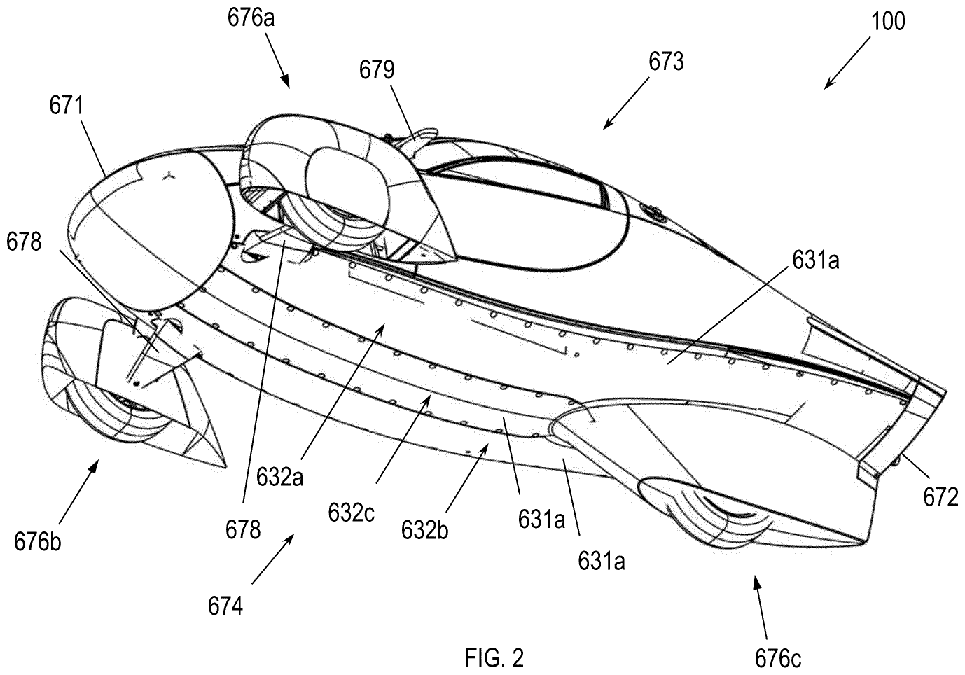

Referring to FIG. 1-9, an aerodynamic vehicle 100 comprises a body 670 including a leading edge 671, a trailing edge 672, an upper body portion 673, a lower body portion 674, the lower body portion 674 having a maximum thickness 675, and a third wheel assembly 676c disposed proximate the trailing edge 672. The body 670 may include a plurality of body panels including a hood panel, roof panel, trunk panel, front-side panel, mid-side panel, back-side panel, door panel, front wheel cover, and/or rear-wheel skirt. The body 670 may further comprise an aerodynamic heat exchanger 630, which may include first, second, and third chambers 632a, 632b, 632c, respectively. Aerodynamic heat exchanger 630 may form a body panel, such as along the underside 674 shown in FIG. 2. The arrangement shown therein provides a heat rejection surface area of about 3 m², which conforms to the aerodynamic body 670 shape of the vehicle 100. Aerodynamic vehicle 100 may further comprise first and second wheel assemblies 676a, 676b, respectively, coupled to the body 670 via one or more aerodynamic struts 678. One or more protuberances 679 may extend outwardly from the body 670 such as, for example, side view mirrors.

In alternative embodiments, aerodynamic heat exchanger 630 may be formed on any exterior portion of body 630, such as one or more of the body panels mentioned. In this context, a body panel refers to an exteriorly-exposed object, i.e., an object exposed to ambient airflow that couples to the structure of the vehicle. Such a body panel may itself form at least part of the structure thereof, or it may couple to a structural frame within body 630.

Although embodiments shown in FIGS. 1-9 include first, second, and third chambers 632a, 632b, 632c, respectively, any number of chambers may be used, and the number, specific sizing, and thermal and/or mechanical coupling of said chambers are non-limiting and considered as being within the scope of this disclosure. For example, two or more discrete chambers may be arrayed in the longitudinal direction, i.e., extending from front end 671 to trailing end 672. Such an arrangement advantageously facilitates manufacturability, serviceability, repair, replacement, and the like of such body panels. As another example, any arrangement of common chambers may be coupled to plant 605 in any known method of one skilled in the art, such as reverse return connections which facilitate uniform return fluid temperature. Furthermore, any fluid may be disposed therein aerodynamic heat exchanger 630, such as, for example, refrigerant, a glycol/water mixture, or water. Aerodynamic heat exchanger 630 may comprise an inner chamber portion 634 coupled to an outer chamber portion 633, which may be fixedly coupled to one another via gasket(s) and one or more fastener assemblies 640, or by any known method. Furthermore, aerodynamic heat exchanger 630 may comprise any material or any combination of materials, for example, aluminum may be used.

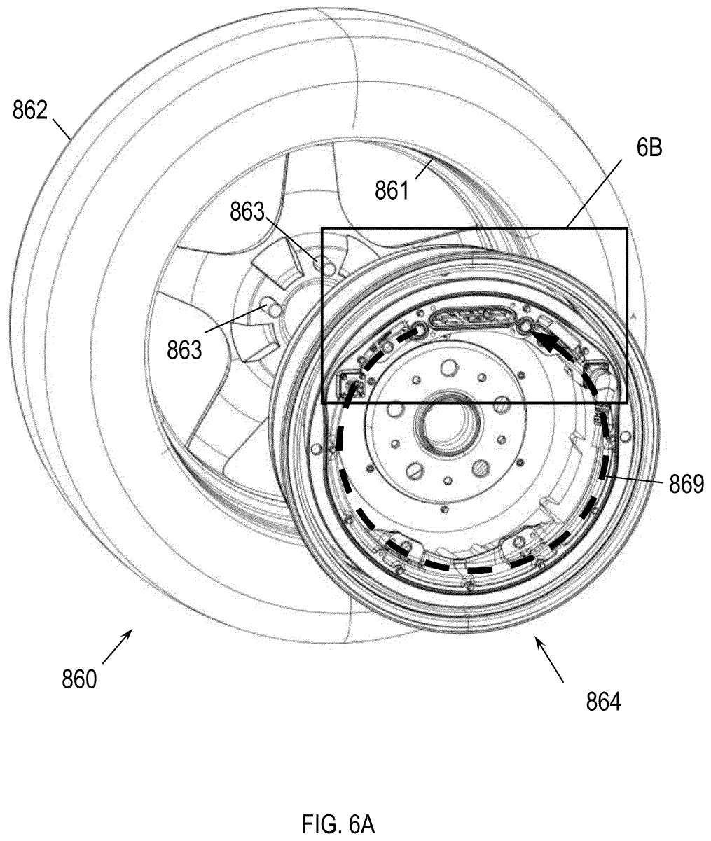

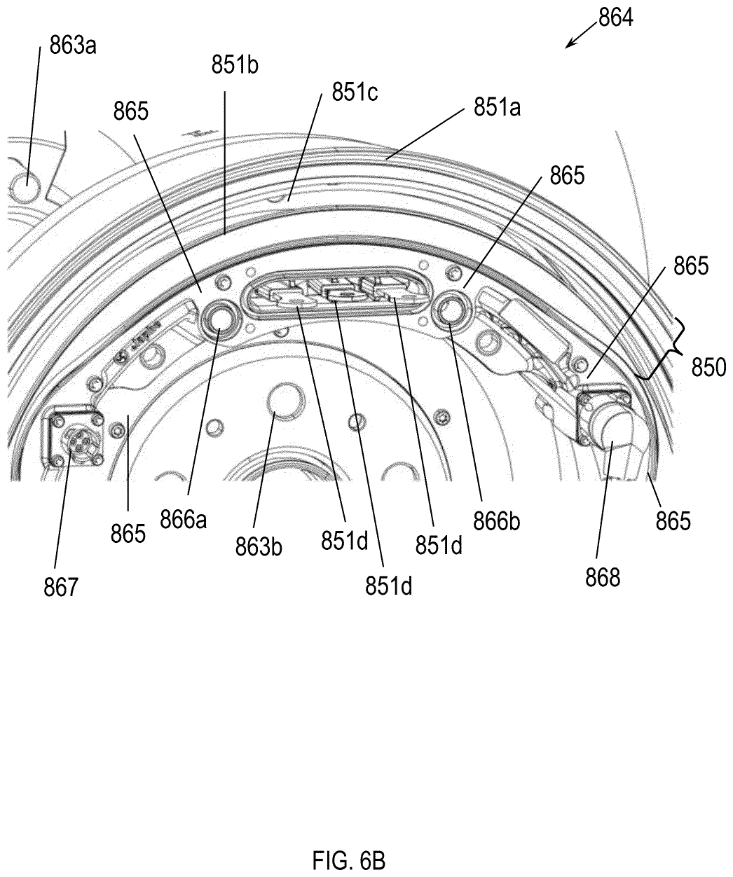

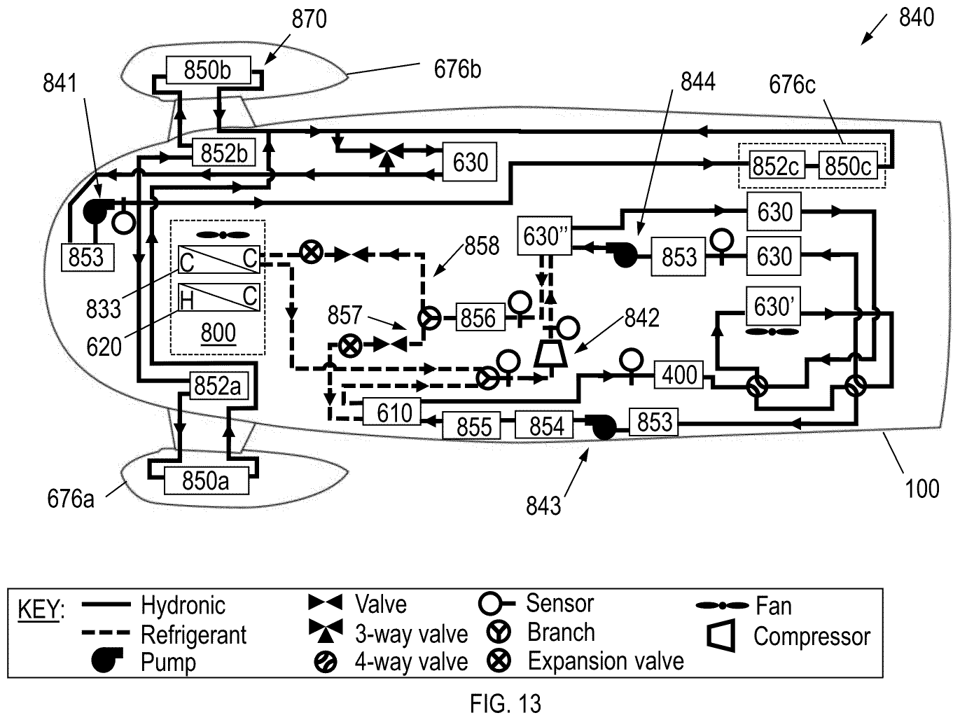

FIGS. 6A and 6B illustrates an exemplary wheel assembly 860 and cooling jacket fluid path 869 according to the present invention. As will be discussed with respect to FIGS. 13-15, the drive flow path 841 comprises the cooling jacket fluid path 869. In the embodiment shown, wheel assembly 860 comprises a wheel 861, a motor assembly 864, and an inverter 852. Wheel assembly 860 may comprise further drivetrain 870 components, and any such components are considered as being within the scope of this disclosure pertaining to thermal management system 840. Wheel 861 may include a tire 862 and one or more fasteners 863a. Motor assembly 864 may include a motor 850, a cooling jacket 865. Motor 850 may include a rotor 851a, a stator 851b, and a motor gap 851c disposed therebetween. According to the design shown, the stator 851b couples to vehicle 100, and the rotor couples to wheel 861 via one or more fastener receivers 863b each configured to receive a corresponding fastener 863a coupled to the tire 862. The stator may include windings (not shown) coupled to a series of three-phase terminals 851d. Importantly, three-phase terminals 851d are fluidly and electrical decoupled from the cooling jack 865, but may be thermally coupled to dissipate heat therefrom. In operation, power to the motor 850 causes the rotor 851a to forcefully rotate about the stator 851b, and motor gap 851c is configured to maintain consistent dimensions with respect to the distance between the stator and rotor 851a, 851b. This action drives the wheel 861 and creates heat. Cooling jacket 865 forms a fluidic cavity coupled proximate to the stator 851b to remove heat from motor 850. In this manner, heat may dissipate from motor 850 either actively through cooling jacket 865 or passively via surrounding airflow as wheel assembly 860 passes through a flow field. Cooling jacket 865 may include an inlet 866a, an outlet 866b, and first and/or second sensors 867, 868. When a fluid is forced through drive flow path 841 from inlet 866a to outlet 866b, the fluid assumes the cooling jacket fluid path 869 shown in FIG. 6A, to provide uniform cooling along substantially all of the motor 850. The flow direction may assume either direction and is not limited to the direction shown. The motor assembly 864 may include first and second sensors 867, 868, which may be a temperature sensor and a wheel speed sensor. Although no substantial delta-T generally occurs across the inlet 866a and the outlet 866b, sensors 867, 868 may both be temperature sensors. Alternatively, any useful sensor may be employed in either location.

Motor 850 may be of the direct-drive in-wheel motor type, available from multiple vendors, such as Elaphe Propulsion Technologies, Ltd., which produces the M700; however, the specific design of the motor contemplated herein is an offshoot of the M700 and is optimized for the specific design requirements for the Applicant. For an Elaphe motor for example, a proprietary method for optimization of motor 850 for use in vehicle 100 may be used. First, the electromagnetic part of the motor may be optimized for efficiency in terms of converting electrical energy to mechanical energy as well as efficiently removing the heat generating. Second, the motor may be optimized for the specific application of vehicle 100, for example, in terms of gross weight, acceleration desired, and steady-state highway driving. In a preferred embodiment, each motor 850 produces about 50 kW of power, as the Applicant has determined based upon power equations on a per-wheel basis that a motor of this size provides the greatest efficiency band for highway driving.

Concerning operating temperatures, several factors go into temperature limits on the upper end of the motor 850 and inverter 852. The Elaphe motor is tested in accordance with certain automotive standards. For example, a motor external temperature range of about −40° C. to about 65° C. (about −40° F. to about 150° F.) is typical for motor testing at full power. For particularly aggressive driving, such as testing on a race track, the motors contemplated herein may be derated as the temperature exceeds this limit, operating at reduced power output from about 65° C. to about 85° C. and would be perceptible to the driver in the form of reduced performance and/or indicators from user interface 815. Over about 85° C. the control system 806 shuts the motors off. Similarly, the design motor external temperature range of about −40° C. to about 65° C. is distinguishable from the internal operating temperature(s) of the motor 850. Here, the insulation on the windings represents the typical limit on internal temperature. As to the inverter 852, the upper temperature limit is about 75° C. (about 167° F.).

There are several benefits to a direct-drive in-wheel motor 850 when used in aerodynamic vehicle 100. A first benefit is that the motor inefficiency is cut approximately in half with a direct-line drive, as compared to conventional drivetrain motors, where the efficiency is considered in terms mechanical over electrical input. Drivetrains having traditional drive shafts are subject to power losses that occur along the drivetrain such as, for example, losses through the gears and/or the universal joints. Generally, any moveable part of the drivetrain system creates efficiency losses and creates parts that wear and need to be replaced. Such penalties with a direct-line drive motor, because the axle bearings are the only moveable interface that attribute to drivetrain power losses. A second benefit is that one or more motors 850 disposed proximate a wheel 861 lower the center-of-gravity of vehicle 100, which increases drivability.

A third benefit is that when using a direct-drive in-wheel motor 850 in aerodynamic vehicle 100, there is substantially reduced or negligible concern of the motor overheating. The aerodynamic drag, i.e., a force imparted by stationary fluid that impedes forward movement of an object in a flow field, increases by the square of the velocity of the object. In conventional vehicle design for instance, the aerodynamic drag force accounts for about two thirds of the total force acting on the motor, i.e., the total force which the motor must overcome to move the vehicle forward at the desired rate of speed. And such drag force, therefore, increase by the square of the vehicle speed, requiring substantially more power from the motor at higher speeds than at lower speeds. The aerodynamic vehicle 100 design optimizes aerodynamic performance by decreasing total air drag 660 (see Table 1 below and related discussion), thereby increasing fuel economy, vehicle performance, and achieving an aerodynamic vehicle 100 capable of traveling about 1,000 miles on a single charge. To that effect, the body shape of aerodynamic vehicle 100 has a design with significantly improved aerodynamic characteristics over conventional vehicles. For example, aerodynamic vehicle 100 achieves a drag coefficient of C_{d}=0.13, as compared to, e.g., a common four-door sedan, like Opel Vectra (class C), having a reported drag coefficient of C_{d}=0.29, or a Tesla model 3 or model Y, having a reported drag coefficient of C_{d}=0.23. See: https://www.engineeringtoolbox.com/drag-coefficient-d_627.html. Given such a high aerodynamic efficiency, Applicant has determined that vehicle 100 consumes about 100 watt-hours per mile, whereas the Tesla Model 3 consumes about 230 watt-hours per mile. This watt-hour comparison is determined over a standard drive cycle, as defined in accordance with EPA Standard For Combined Highway and City Driving. This equates to less heat rejection required as compared to conventional design as well as other efficiency benefits such as reduced power consumption and increased vehicle range.

A fourth benefit is that, because the motor 850 is disposed proximate the wheel 851, the ambient airflow provides passive or “free” cooling of the motor 850. Although vehicle 100 is partially characterized by a wholistic approach to reducing drag and increasing aerodynamic efficiency and vehicle performance, the wheels 851 necessarily must touch the ground at a certain contact patch. Therefore, drag mitigation measures, like wheel skirts, etc., can streamline airflow around the wheel assembly, e.g., 676a, 676b, 676c, only to a certain extent. This causes air to circulate within the first, second, and third wheel assemblies, 676a, 676b, 676c and out of the same, thereby passively transferring heat to the ambient air field. Referring to FIG. 10 which illustrates center-line streamlines running longitudinally along vehicle 100, a laminar region 669b is shown extending along the lower body portion 674 from front end 671 to over at least a portion of third wheel assembly 676c. A turbulent region 669c is shown proximate third wheel 861c, which reflects the airflow within, through and out of wheel assembly 669c, and around third wheel 861c. Referring to FIG. 11 which illustrates flow separation regions: flow separation region at body 680a, flow separation region at protuberance 680b, and flow separation region at wheel assembly 680c. Of particular relevance to the instant application, flow separation 680c may be observed trailing from first and third wheel assemblies 676a, 676c. Contained within these flow separations 680c is dissipative heat energy from motors 805, such as motors 850a and 850c, respectively. In this way, drivetrain apparatus, system, and method 870, and thermal management system 840 may be configured to benefit from the identified structural characteristics that result in passive, “free” cooling of the motor 850.

Referring to FIGS. 6A and 6B, regarding cooling of direct-drive in-wheel motor 850 and in a preferred embodiment, one or more motors 850a, 850b, and 850c each corresponding to one or more of first, second, and third wheel assemblies 676a, 676b, 676c, may employ a liquid cooling connection such as a drive flow path 841 of drivetrain system 870, as previously described. As will be discussed in further detail below with respect to FIGS. 13-15, thermal management system 840 may comprise drive flow path 841 as it relates to certain water-side components. Drive flow path 841 thermally couples to each of said one or more motors 850 to actively remove heat generated by propulsion of vehicle 100 to maintain an external motor temperature of under about 65° C. (about 150° F.) when motor 850 provides full power. Drive flow path 841 therefore transfers heat away from motor 850 to a heat exchanger, such as first chamber 632a of aerodynamic heat exchanger 630, however, any specific number or of chambers may be used, or any specific arrangement of heat exchanger 630. Similarly, drive flow path 841 may be thermally coupled to a supplemental heat exchanger, such as additional heat exchanger 630′. Heat may be conveyed in any appropriate fluid, such as, for example, water or a water/glycol mixture.

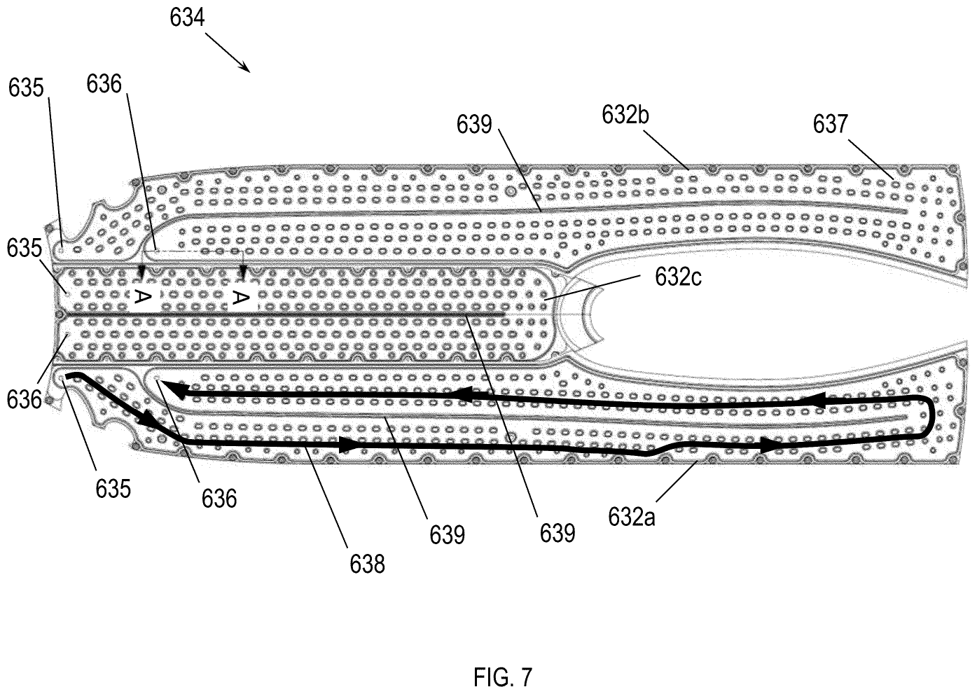

FIG. 1 also shows inner heat exchange surfaces 631a of aerodynamic heat exchanger 630, which defines at least one of the interiorly-exposed surfaces from which the supplemental heat exchange system 630′ exchanges heat. FIG. 2 also shows an outer heat exchange surface 631b, which forms primary heat rejection of aerodynamic heat exchanger 630 to the ambient environment. Therefore, according to the present invention, aerodynamic heat exchanger 630 represents a dual-mode heat rejection, or heat exchange, system capable of advantageously using either or both sides of the apparatus. FIG. 7 shows the interior side of an inner chamber portion 634 of aerodynamic heat exchanger 630. Inner chamber portion 634 may be manufactured in discrete portions corresponding to first, second, and third chambers 632a, 632b, 632c, respectively, or may be manufactured as a single element, or in any number of chambers. Each chamber 632a-c may comprise an inlet opening 635, an outlet opening 636, indentations 637, which may be stamped features 637, a fluid channel 638, and a channel divider 639. Fluid channel 638 may comprise and be composed of an entirety of the wetted surfaces formed by portions of inner chamber portion 634 coupled and outer chamber portion 633. Alternatively, fluid channel 638 may comprise a streamline path of a plurality of flow paths, such as that shown in first chamber 632a of FIG. 7, extending between inlet opening 635 and outlet opening 636. The flow direction in any chamber, such as chambers 632a, 632b, 632c is exemplary, and the opposite flow direction may be used.

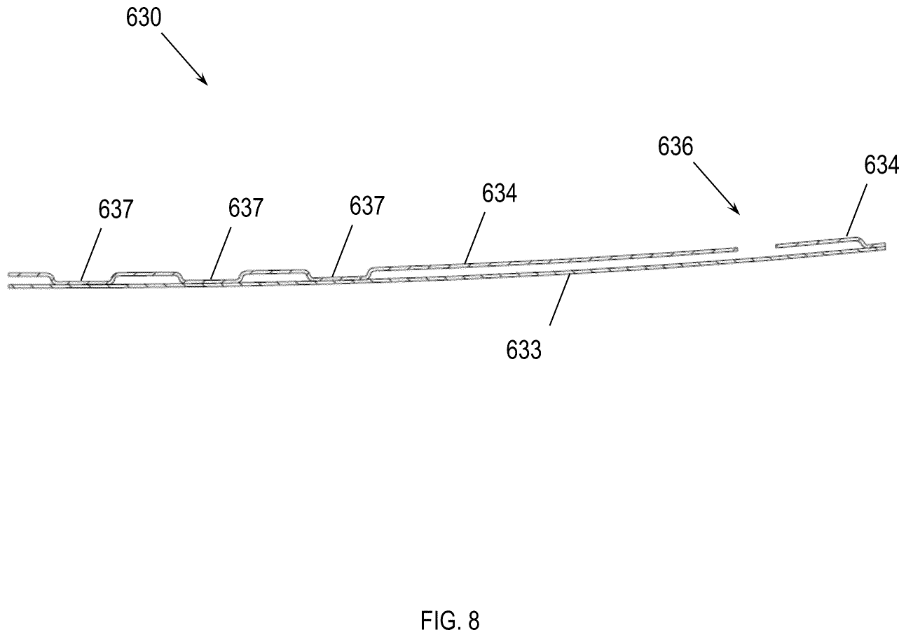

As shown in FIG. 8, a cross-sectional view of inner chamber portion 634 and outer chamber portion 633 of second chamber portion 632b along line A-A, illustrates the indentations 637 that provide mating surfaces for the outer chamber 633 and inner chamber portion 634. Indentations 637 may be formed by stamping and other manufacturing technologies, and joined by braising, welding, fastening or bonding with thermally conductive adhesive. The indentations 637 may comprise portions of inner and outer chamber portions 634, 633 that form flow barriers along a portion of indentation 637 where flow is to be prohibited, to promote a serpentine path, and to provide desirable mixing effects. Alternatively, the indentations 637 may comprise only inner chamber portion 634 in a space or void that exists between each indentation 637 and outer chamber portion 633. One or more channel dividers 639 may be used to form an extended fluid separation along a length of each chamber 632a-c. The effect of each channel divider is to promote fluid migration to one or more offset dimensions between a physical distance from the inlet 635 and/or outlet 636, which also promotes more effective heat transfer. In the embodiment shown in FIG. 7, The one or more channel dividers force(s) the flow to travel the length of the section 632b and back, thereby providing maximum contact area between the fluid and the radiator 631. Other macro flow paths 638 are also possible as facilitated by the one or more channel dividers 639 that may result in a serpentine path. Within the fluid chamber 638, indentations 637 may be uniform or otherwise discrete and may be arrayed in any suitable manner to cause turbulent flow that further increases the efficiency of heat transfer from the fluid to the aerodynamic heat exchanger 630.

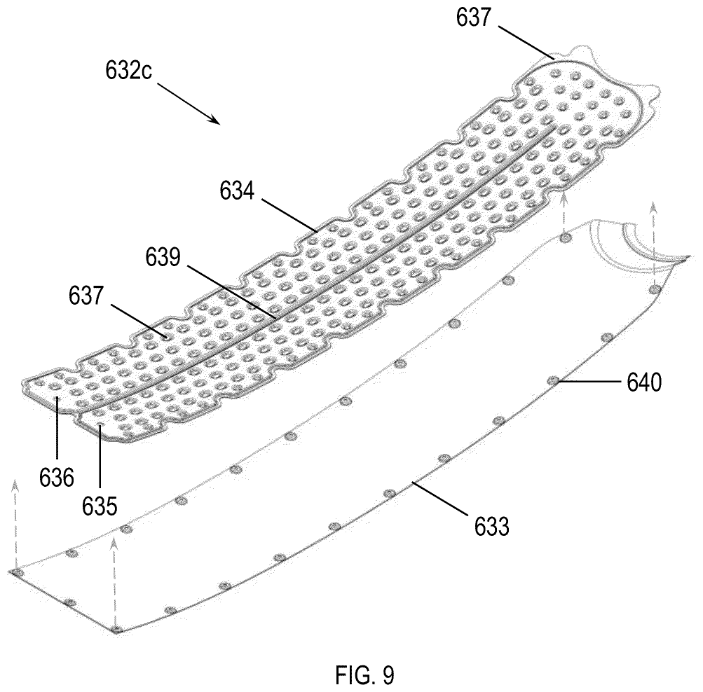

FIG. 9 shows an outer chamber portion 633, which similarly may be manufactured as a single element and/or in discrete portions corresponding to first, second, and third chambers 632a, 632b, 632c, respectively. The outer chamber portion 633 may be formed to provide the desired aerodynamic characteristics including fastener assemblies 640 being formed substantially flush with the outer surface of outer chamber portion 633 such that the flow is not perturbed, remains laminar and/or is otherwise conducive to low drag. Such fastener assemblies 640 may be disposed along the entirety of the perimeter of each chamber 632a-c, or may be formed along a portion thereof. Other locations may couple to further components of aerodynamic vehicle 100 using suitable fasteners, adhesives and/or other coupling methods. FIG. 9 shows an exploded view of third chamber 632c comprising inner chamber portion 634 and how it may be coupled, or otherwise arranged to outer chamber portion 633.

Having described certain structural attributes, drive system 870 and aerodynamic heat exchanger 630 are now described in the context of its configurations within thermal management system 840. FIG. 12 is a schematic view illustrating the thermal management system 840 wherein each type of component may contain one or more of the same component, but preferably has the quantity shown, i.e., one or multiple. A thermal management system 840 as represented in FIG. 13-15 is useful for illustrating the environment in which the present invention pertains and is provided for in the context of its functional components. The thermal management system 840 may comprise plant and demand system 605 and 650, respectively, as well as controls 805 thereof and a user interface 815. The phrase “user interface” in this context may refer to any type of surface capable of receiving a command from a user within a vehicle, including but not limited to a touchscreen, a touchscreen having one or more knobs and/or buttons protruding therefrom, and a digital display with or without control knobs and/or buttons.

A plant 605 typically defines where energy is transferred, or transformed, from one form to another, and it may include a chiller 610 that defines a source of cooling, one or more heating elements 620 which define a source of heating. And then a plant 605 may also include various exchangers, such as an aerodynamic heat exchanger 630 to reject heat to the ambient, but also heat exchangers disposed within the vehicle 100, such as for exchange of heat among dissimilar media, like refrigerant-to-water, refrigerant-to-air etc. Plant 605 may also include cooling coils 833 to condition an airflow conveyed by an airside system (not shown here), such as a fan, and passed through air flow channels and vents to cabin 800. The heating elements in this context may be one or more electric heating coil, but other types of heating elements are considered herein as well.

Demand systems 650 may comprise motors 850, inverters 852, batteries 400, and a cabin 800 and/or other components that require heating, ventilation, and/or air conditioning. Components comprising demand systems 650 may be in any arrangement of thermal communication with said plant system 605 components that is useful to achieve the desired objective. Furthermore, each class or type of subcomponent for which demand systems 650 comprises may be circuited to/from a dedicated chiller 610, a dedicated heat exchanger 630, a dedicated heating element 620, and/or a dedicated cooling coil 833. Cooling energy may originate in the plant 605 within the chiller 610 via a compressor-powered refrigerant loop, or with “free cooling” employed by one or more aerodynamic heat exchangers 630—a heat transfer method that takes advantage of the ambient temperature being colder than the temperature of the demand system 650 component to be cooled. Similarly, heating energy may originate in the plant 605 within a heating element 620, or with “heat pump” activation of the chiller cycle, or with “free heating” employed by one or more aerodynamic heat exchangers 630. In general, separate heat exchangers 630 are characterized as having a dedicated inlet and outlet, but other characterizations fall within the scope of this disclosure as have been described herein. In an example embodiment of potential combinations of plant 605 and demand 650 systems components, vehicle 100 comprises three aerodynamic heat exchangers 630, two heat exchangers mechanically and thermally coupled to the battery 400 and cabin 800, and one aerodynamic heat exchanger 630 mechanically and thermally coupled to the motors 850 and inverters 852.

The user interface 815 can be formed as a display having a touchscreen designed to give the user control over many aspects of the plant and demand systems 605, 650 of the vehicle 100. For example, the user interface 815 can be used to control temperature, humidity, and/or ventilation conditions of the various components defined by demand systems 650. Passenger-input to the user interface 815 may determine whether cabin 800 demands heating, cooling and/or ventilation, whereas computer-controlled commands determine input and output to other demand systems in a passive, i.e., non-passenger-input manner. Furthermore, via the HVAC control system 805, the user interface 815 may provide airflow and temperature control within discrete locations of the cabin 800, such as control to individual passengers or the driver, and also to cabin 800 locations, such as the floor, chest level, head level, ceiling, or windows via selection of appropriate airflow channels and/or directional control of vanes.

HVAC control system 805, and control subsystems 806 thereof, can include controllers, processors, memory, and storage. The HVAC control system 805 can send instructions to the airside and plant systems 605, 820. The HVAC control system 805 can also receive feedback from conditions of the various components of demand systems 650, via various sensors 601, e.g., for temperature, humidity, voltage, amperage, impedance, etc., and/or cameras, to further specify desirable conditions therein and thereof. Furthermore, the HVAC control system 805 can send information to the display of the user interface 815 to display setpoints and the like to be viewed by the user or controlled automatically by the control system 805. Additionally, all manner of sensors may be deployed throughout locations in the system 600, such as thermistors and the like, to form the basis of controlling intelligently the characteristics of the demand systems 650 and/or plant system 605.

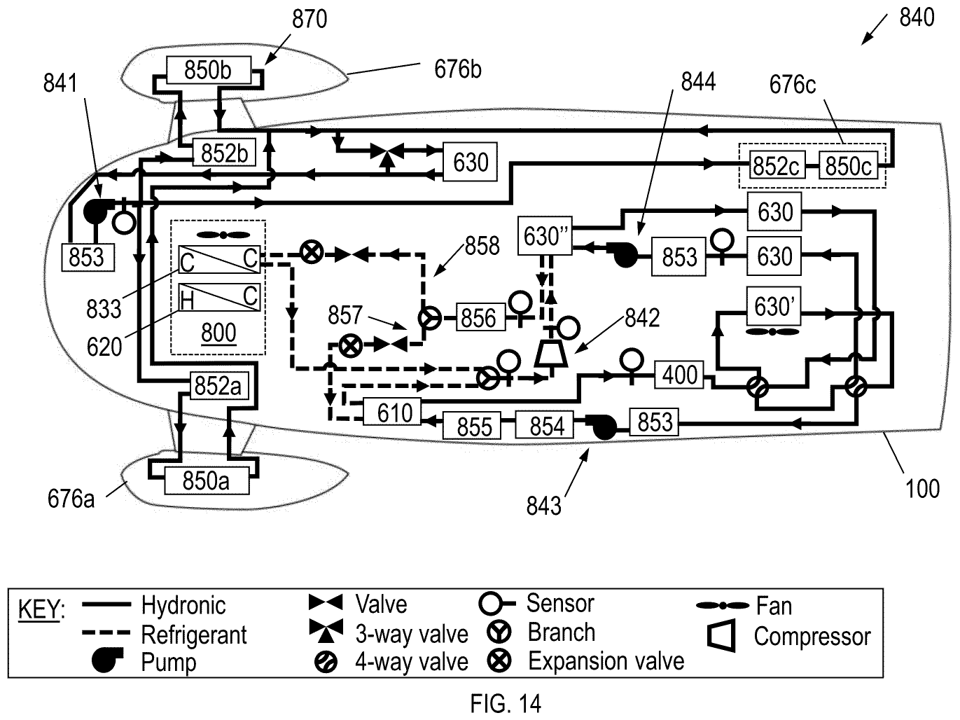

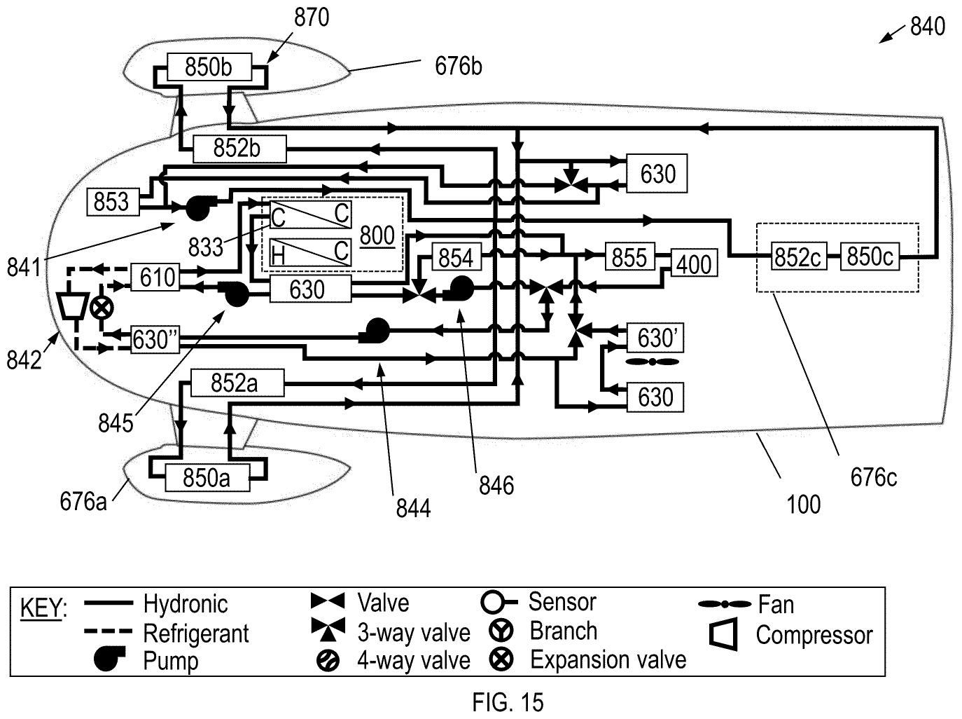

FIGS. 13-15 show water-side system components that pertain to thermal management system 840 of FIG. 12, and that also pertain to the various embodiments and concepts related to FIGS. 1-11. In one embodiment, FIG. 13 illustrates heat rejection of the cabin 800 and/or battery pack 400 where the chiller 610 is OFF, and FIG. 14 illustrates the same but where the chiller is ON. In this embodiment, the cabin 800 and battery pack 400 demand systems 650 are arranged parallel with respect to the compressor. In an alternative embodiment, FIG. 15 illustrates the cabin 800 and battery pack 400 demand systems 650 arranged in series with respect to a chiller 610. In all arrangements contemplated herein, one skilled in the art will appreciate that the drive flow path 841 is thermally and mechanically decoupled from the various other flow paths of the thermal management system 840, under all driving conditions. This arrangement advantageously provides greater energy savings, which has implications across the electric vehicle 100, such as further single-charge driving distance, a simplified drivetrain 870, reductions of parts, and cost savings. It should be noted that the arrangement of components of thermal management system 840 as shown in FIGS. 13-15 are represented diagrammatically against the outline of vehicle 100 for ease of illustrating various concepts, where the physical locations of components may differ from what is shown.

Referring to FIGS. 13 and 14, thermal management system 840 may comprise a drive flow path 841, a refrigerant flow path 842, a battery flow path 843, and a heat rejection flow path 844. Drive flow path 841 may include a pump that drives fluid to one or more inverters 852, such as first, second, and third inverters 852a, 852b, and 852c, respectively. From inverter 852, fluid may flow to one or more motors 850, such as first, second and third motors 850a, 850b, and 850c. In the embodiment shown, first, second, and third inverters 852a, 852b, 852c, as well as first, second and third motors 850a, 850b, 850c correspond to first, second, and third wheel assemblies 676a-676c, having first, second and third wheels 861a-861c. In alternative embodiments, only one motor 850 and inverter 851 may be utilized in drivetrain system 870, such as a single drive front or back wheel. Or, a plurality involving any number of motors 850 and inverters 851 may be used corresponding to the number of wheels 861 employed. From motor 850, fluid may then flow to one or more aerodynamic heat exchangers 630 to reject heat to the ambient environment. In an alternative embodiment, drive flow path 841 may reject heat to a fan-powered heat exchanger, such as supplemental heat exchanger 630′. A three-way valve may be disposed before the inlet to heat exchanger 630, 630′, to thermal decouple the heat exchanger from the drive flow path 841. Such an arrangement may be useful when ambient temperatures are cold and the vehicle 100 is starting up; the fluid circulation through the drive flow path 841 in this arrangement facilitates the one or more motors 850 and one or more inverters 852, as well as any other drivetrain 870 components to reach desirable operating temperatures. A tank 853 may be employed in drive flow path to provide, for example, thermal mass to the system. Similar tanks 853 may be employed in other flow paths of thermal management system 840 such as, for example, tanks 853 prior to pump inlets on battery flow path 843 or heat rejection flow path 844.

The refrigerant flow path 842 shown in FIGS. 13 and 14 arranges cooling coil 833 and chiller 610 in parallel with the compressor, through the use of cabin and chiller refrigerant branches 858 and 857, respectively. This parallel arrangement allows for four operating conditions of the refrigerant flow path 842, where cabin and chiller refrigerant branches 858 and 857 include a controllable shut-off valve prior to each expansion valve. In a first scenario, branch 857 may be shut while branch 858 may be open, which provides cooling energy to cooling coil 833 to cool cabin 800 independent of chiller 610. In a second scenario, branch 858 may be shut while branch 857 remains open, thereby providing cooling energy independently to chiller 610. In a third scenario, both branch 857 and 858 may be open, to provide simultaneous cooling to both cooling coil 833 and chiller 610. In a fourth scenario, both branches 857 and 858 may be closed, corresponding to no cooling demand of demands system. Under the last scenario, heating elements may be employed independently, in combination, or otherwise as needed; heating element 620 may be turned on to heat cabin 800, and/or positive temperature coefficient (PTC) heating element 854 may be turned on to provide heating to battery pack 400 and/or other components for which thermal coupling to battery flow path 843 may be appropriate. As shown in FIG. 13, and in either the second or third scenario where the chiller 610 is ON, two 4-way valves may be employed in the configuration shown so that the battery pack 400 and any associated components, e.g., on-board charging (OBC) 855 can be thermally coupled to chiller 610 for cooling thereof.

Concerning the heat rejection flow path 844 shown in FIGS. 13 and/or 14, the compressor of the refrigerant flow path 842 flows superheated fluid to a heat exchanger 630. That heat exchanger 630, on the side of the heat rejection flow path 844, is configured to first pass fluid to aerodynamic heat exchanger 630, then to supplemental heat exchanger 630′. Under this configuration if primary heat exchanger 630 does not offer the necessary capacity (e.g., vehicle 100 is traveling <10 mph) additional capacity is activated via a fan disposed proximate supplemental heat exchange 630′. As fluid returns to the pump of heat rejection flow path 844, an optional aerodynamic heat exchanger 630 may be serially disposed in the flow path 844.

FIG. 13 generally, but not necessarily, corresponds to a chiller 610 ON configuration. Regarding battery flow path 843, flow from the outlet of the batter pack 400 is redirected to tank 853 and/or the pump. Here, heat energy is transferred out of the batter pack 400 to the fluid, and removed from battery flow path 843 via chiller 610, to be ultimately rejected by heat rejection flow path 844 in one of the aforementioned operating conditions. One or more 4-way valves may be used to facilitate this fluidic communication. Conversely in FIG. 14, one or more 4-way valves may be used to reject heat from battery pack 400 to supplemental heat exchanger 630′, when ambient conditions are cold enough, to operate under a reduced energy consumption configuration. Here, the chiller 610 is OFF, and the valve of chiller refrigerant branch 857 may be closed and/or the compressor of refrigerant flow path 842 may be OFF. In this way, the 4-way valve configuration shown and described in FIGS. 13 and 14 benefits from alternative configuration to transfer heat away from the battery pack 400, cabin 800, and other components, while drive flow path 841 remains thermally and mechanically decoupled from chiller 610, and more generally refrigerant flow path 842, under all operating conditions of vehicle 100.

Referring to FIG. 15, an alternative embodiment of thermal management system 840 is shown. As before, drive flow path 841 remains thermally and mechanically decoupled from chiller 610, and more generally refrigerant flow path 842, under all operating conditions of vehicle 100. Here, refrigerant flow path 842 circulates fluid through a simple refrigeration cycle comprising a compressor, a condenser/heat exchanger 630, an expansion valve, and an evaporator/chiller 610. A chiller hydronic flow path 845 then flows fluid from chiller 610, to a cooling coil 833, then to another heat exchanger 630. This heat exchanger 630 is then thermally and/or mechanically coupled to a battery flow path 846, which flows fluid from heat exchanger 630 to battery pack 400, and back. A 3-way valve may be used to remove heat exchanger 630 from the battery flow path 846 and instead engage a heating element, such as PTC 854 when heat is demanded. Via a series of 3-way valves, analogous to the embodiments described in FIGS. 13-14, battery pack 400 may benefit from a reduced energy consumption configuration by rejecting heat directly to supplemental heat exchanger 630′ and/or aerodynamic heat exchanger 630. And analogous to the embodiments described in FIGS. 13-14, in FIG. 15 a heat rejection flow path 844 may operate to transfer heat from the refrigerant flow path 842 to either or both of the one or more aerodynamic heat exchangers 630 and/or one or more supplemental heat exchangers 630′.

Regarding sensors employed in any of the configuration contemplated in FIGS. 13-15, any manner of sensors may be employed to provide feedback to control system 806, to user interface 815, or for other purposes, or to otherwise provide state points and other information throughout thermal management system 840 and flow paths, e.g., drive flow path 844. Any sensor know in the art may be employed. For example, a thermostatic temperature sensor and/or pressure sensor may be located at the outlet of drive flow path 844 pump. Various sensor locations are provided in FIGS. 13 and 14, and may similarly be extended to FIG. 15. However, any location throughout thermal management system 840 may be employed to provide any state variable via a sensor.

FIGS. 1-15 illustrate structures of an embodiment of the aerodynamic vehicle 100 that result in a low total drag coefficient, of about C_{d}=0.13, as can be measured using computational models and tools for fluid dynamics, CFD, and other simulations showing the results in the high aerodynamic performance of the inventive aerodynamic heat exchanger 630 to provide increased fuel economy and/or vehicle driving range—as in the case of an electric battery powered vehicle. CFD simulations and analysis are known tools and although a thorough explanation lies beyond the scope of this disclosure, an elementary explanation may aid in understanding of the underlying theory from which the structure of the present invention relates. CFD applies to a body, such as body 630, or more completely aerodynamic vehicle 100, surrounded by a fluid flow having boundary conditions at some distance away from the body. Boundary conditions 681 along the perimeter as shown in FIG. 10 is one such example, where conditions that accurately define such characteristics as a uniform flow field and also rigid bodies such as the road surface. The flow field for which a solution is sought then lies within that boundary 681 and around vehicle 100, which requires the solution of three-dimensional Navier Stokes equations. The flow field is assumed to be a continuous medium that is discretized into points along the flow field, then data values are determined using tools including a numerical solver and arranging the terms in an appropriate way, such as, for example, in one or more tri-diagonal matrices, characteristics including but not limited to velocity, V, pressure, p, and shear stress τ. Such tools provide data values in an iterative vehicle design, where structural aspects can be varied and aerodynamic flow field effects observed. Other tools include vehicle models and/or prototypes designed for small-scale wind tunnel testing and/or full-scale analysis using sensors, etc., so as to evaluate designs. These analyses also produce predictive results as shown in FIG. 11, where flow separations may be accurately captured and observed.

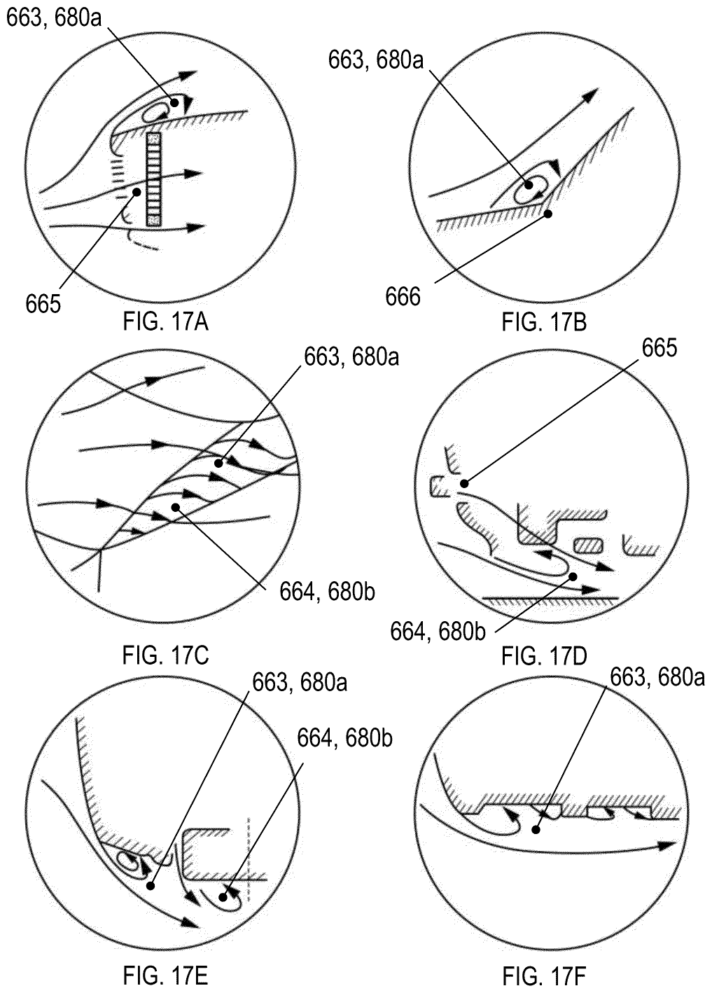

FIGS. 16 and 17A-17F illustrate certain aerodynamic aspects and parameters relating to the heat exchanger 630 formed with the structures and panels of an aerodynamic vehicle 100. As used herein, many of the drag forces acting on a vehicle and their interrelated design factors are shown the Table 1 below for ease of describing the claimed invention.

According to Table 1, total air drag 660 acting on a vehicle includes external drag 661 and internal drag 662 components. External flows in this context, from which external drag 661 results, refers to unconfined flows occurring over surfaces including, but not limited to, one-sided surfaces, flat plates, circular cylinders, vehicle body panels, and other surfaces. External drag 661 can then include body drag 663 and protuberance drag 664, where the former generally refers to drag from a primary body, and the latter generally refers to drag from an object or component that protrudes outwardly from the surface of the primary body. Protuberance drag 664 may also account for the confluence of airflows, i.e., localized mixing, between the protruding object and the body from which it extends. Body drag 663 can be decomposed into mutually-orthogonal forces, pressure drag 663a, p, which acts normal to the surface of a body, and friction drag 663b, a shear stress, τ, that acts tangential to the surface.

Internal flows in this context, from which internal drag 662 results, refers to flows occurring in confined passages of various regular or irregular, singly or doubly connected, constant or variable cross sections including, but not limited to, circular, rectangular, triangular, annular, and other cross sections. Internal drag 662 can include engine cooling drag 665, ventilation drag 666, and component cooling drag 667.

FIGS. 16 and 17A-17F further illustrate some of the ways in which total air drag 660 traditionally manifests in the form of a flow field around a vehicle. Such a conventional flow field is characterized by numerous flow separations, a concept related to drag that will be further elaborated upon below. The following qualitative explanation regarding FIGS. 17A-17F demonstrates some of the types of drag that typically occur, but additional subcategories of drag may be applicable thereto, and additional formulations as to the decomposition of total air drag 660 may be similarly applied. Therefore, the application of the Table 1 framework to the various figures and/or in the specification shall be construed as non-limiting, and is generally being used to aid in understanding of central concepts pertinent to the present invention.

In contrast to the flows around aeronautical configurations, the road vehicle flow field is characterized by flow separation regions both large and small. These flow separation regions may exhibit quasi-two-dimensional or fully three-dimensional flow fields. In the case of the former, the representative flow fields shown in FIGS. 17A, 17B, and 17D-17F represent quasi-two-dimensional flow fields. In contrast, FIG. 17C as illustrated represents a fully three-dimensional flow field. The smaller regions of local separation occur at body appendages, like protuberances 664, including headlights, mirrors, door handles, windscreen wipers, and other appendages. Large areas of separated flow are present at the trailing perimeter of the vehicle body and on the underside or undercarriage of a conventional vehicle, as in FIG. 17D, where the flow is disturbed by mechanical and structural elements and by the rotating wheels.

In the case of the front-end radiator, for example as in FIG. 17A, this form of heat exchanger relies on air being forced in between the array of small fins and tubes—a process that increases drag, and which is classified as engine cooling drag 665. Such front-end conventional designs may also include body drag 663 resulting from a body flow separation region 680a. FIG. 17B illustrates the intersection of the hood and the windshield, with body drag 663 resulting from a body flow separation region 680a, and ventilation drag 666 resulting from a cowl inlet for fresh air to the cabin. Ventilation drag 666 with cowl inlet is representatively shown in FIG. 16. FIG. 17C illustrates how flow over the side of the windshield along the driver's-side door experiences body drag 663 resulting from a body flow separation region 680a and localized protuberance drag 664 and associated protuberance flow separation region 680b resulting from a side-rear view mirror (not shown) that extends outwardly from the body of the vehicle.

FIG. 17D illustrates, in a centrally-disposed cross-section, flow though the front-end grille resulting in body drag 663, 680a and engine cooling drag 665, and a front fender spoiler, which may be characterized as protuberance drag 664, 680b that extends underneath the vehicle and acts to form a larger effective front-end area, thus also increasing and contributing to body drag 663. In the case of an electric vehicle having an undercarriage base plate, for example, vehicle components forward of the heat exchanger, such as the suspension and openings in the undercarriage, effectively ‘trip’ the flow, causing the airflow to become turbulent—a design aspect that also increases drag. These designs may employ a spoiler, such as the spoiler as in FIG. 17D located on the front fender, to try to mitigate such drag effects, but the aerodynamic contribution to increased drag still remains. Also, the addition of such components employed to offset aerodynamic contribution add weight to the vehicle, thereby decreasing fuel economy and performance.

FIG. 17E illustrates, in a cross-sectional view, flow extending around the driver's-side body and wheel, body drag 663, 680a, and extending within the wheel to cool brakes, e.g., disk brakes, drum brakes, brake shoe, resulting in component cooling drag 667. The tire may also be characterized in terms of protuberance drag 664, 680b with flow interactions of the same with the surrounding vehicle body. Lastly, FIG. 17F illustrates a top view of flow around the driver's side extending over the front and rear doors of the vehicle, resulting in body drag 663, 680a. Each of the aforementioned examples include flow separation, which is representative of regions having eddies and/or recirculation regions.

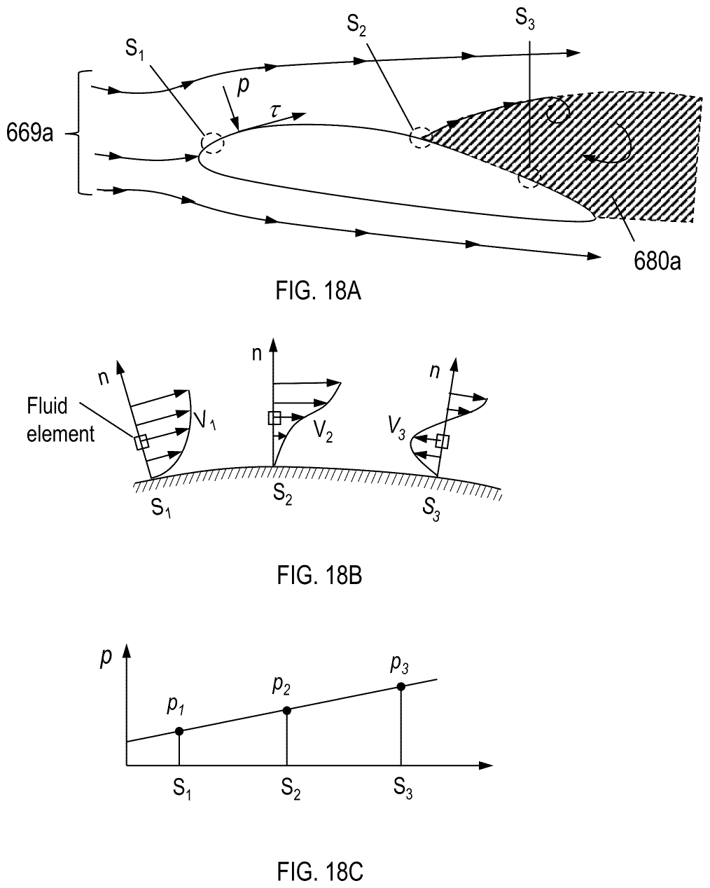

FIGS. 18A-18C illustrate the aspects, concepts, and terms used to describe the present invention flow separation as applied to aerodynamic heat exchanger 630 in a viscous flow field. As shown in Table 1, external drag 661 exerted on a body can be defined as the summation, or decomposition, of pressure drag p, 663a and friction drag τ, 663b, where p represents the per unit area force acting normal to the surface of the body, and τ represents the per unit shear stress acting tangentially to the surface of the body. For a slender body, like aerodynamic vehicle 100, which has an aspect ratio of approximately 1:4, height to length, laminar flow is desirable and moreover, τ>>p. In contrast, for a blunt body, like a cylinder or sphere having an aspect ratio of 1:1, height to length, turbulent flow is desirable, and moreover, p>>τ. Laminar flow in this context refers to a flow where the velocities are free of random fluctuations at every point in the flow field, and thus the flow is highly ordered. Turbulent flow in this context refers to a flow where the fluid particles do not travel in a well-ordered manner and, instead, the flow of fluid particles is very irregular and tortuous. As will be described, in the case of the body shown in FIG. 18A—as is the case with aerodynamic vehicle 100—it is desirable to keep the flow from separating to maintain laminar flow, thereby reducing friction drag τ, and pressure drag p.

FIG. 18A illustrates a condition where the body is subject to a uniform flow field 669a and flow separation occurs along the characteristic length of the body. Within the boundary layer, the influence of friction, i.e., friction drag τ, creates V=0 when the coordinate normal to the surface n=0, which exists for each position S₁, S₂, and S₃, i.e., ‘no slip condition’ for fluid particles at the surface of the body as shown in FIG. 18B. The region of flow near the surface has velocity gradients, ∂V/∂n, which are similarly due to the frictional forces between the surface and the fluid. As shown in FIG. 18B, as the fluid element travels across positions S₁, S₂, and S₃, the corresponding changes in velocity V₁, V₂, and V₃ corresponds to an adverse pressure gradient p₃>p₂>p₁ as shown in FIG. 18C. Also, V₂ slows due to friction at S₂, and at S₃, which represents the flow in its earliest moments of being started, V₃ is negative. As the flow develops, at S₂ for n=0, flow separation occurs and that fluid particle separates from the surface, causing a large wake of recirculating flow downstream of the surface Beyond this point, reversed flow occurs. Therefore, in addition to the generation of shear stress, the influence of friction can cause the flow over a body to separate from the surface. When the flow separates, such as the flow separation region 680a of FIG. 18A, the pressure distribution over the surface is greatly altered. The uniform flow field 669a that extends over the leading of the body no longer sees the complete shape of the body, but instead, sees the body upstream of the separation point, and that pressure force is instead integrated over the entire “effective body”, thereby increasing pressure drag, p, 663a. Similarly, the flow downstream of the separation point becomes turbulent, which similarly increases friction drag τ, which for slender bodies results in increased total drag. Therefore, when separation occurs over an arbitrary shape having sufficiently slender characteristics, e.g., 3:1, 4:1 as is the case with a representative vehicle, either or both of the representative components of external drag 661, pressure drag p and friction drag τ may be adversely affected, the resultant summation of external drag 661 increases, as does the total drag 660 acting thereon. From a design perspective, keeping the flow from separating is one aspect that positively affects the aerodynamic performance of a vehicle, and this may be achieved in part by avoiding the design features common to conventional vehicles, as shown in FIGS. 16 and 17A-17F.

Aerodynamic vehicle 100 including aerodynamic heat exchanger 630 is now considered in the context of heat transfer design aspects. Among the most important inputs for the thermal design of a heat exchanger are the dimensionless heat transfer coefficients. Depending on whether the heat exchanger design can be classified as having external flow or internal flow—analogous to the aerodynamic considerations of external drag 661 and internal drag 662 of Table 1—different models may be used to approximate design aspects thereof. For example, an external flow heat exchanger, such as a surface exposed to ambient air flow, velocity and temperature boundary layer theory may be more suitable for approximating conditions therealong. As another example, for predominantly an internal flow heat exchanger, potential flow theory may be more suitable for approximating conditions, e.g., velocity and temperature profiles beginning with flow through a pipe inlet, to developing flow, and to developed flow therealong. Because of nonlinear relationships among geometry and operating conditions for a given heat exchanger design, i.e., given selected values for width, length, depth, fin spacing, materials, etc., data obtained for one exchanger size cannot be used to size or rate accurately a heat exchanger of a different size. Therefore, the surface characteristics of a given heat exchanger design, e.g., rejection capacity, are primarily obtained experimentally for most exchanger surfaces because the flow phenomena are complex due to the geometric features of flow area and/or heat transfer surface.

The previous description of the disclosed embodiments is provided to enable any person skilled in the art to make or use the invention. Various modifications to these embodiments will be readily apparent to those skilled in the art, and the principles defined herein can be applied to other embodiments without departing from the spirit or scope of the invention. It is therefore desired that the present embodiments be considered in all respects as illustrative and not restrictive, reference being made to the appended claims as well as the foregoing descriptions to indicate the scope of the invention.

1. A thermal management system for an electric vehicle comprising:
a drive flow path including one or more mechanical energy conversion devices consisting of one or more liquid flow regulating devices, at least one inverter, at least one motor, and at least one heat exchanger, said drive flow path adapted for coupling said one or more liquid flow regulating device, said at least one inverter, said at least one motor, and said at least one heat exchanger, said drive flow path further adapted for transferring heat from said inverter and said motor to said heat exchanger,
wherein said drive flow path is decoupled from a refrigerant flow path under all operational modes of said electric vehicle, and said refrigerant flow path is adapted for providing cooling to a cabin and/or a battery pack.

2. The thermal management system of claim 1 wherein said at least one motor is a direct-drive, in-wheel motor, each of said at least one motors being disposed proximate or within a wheel and disposed at least partially within a wheel housing, wherein said wheel housing is physically spaced away from a body of said electric vehicle so that said wheel housing is almost entirely surrounded by an ambient airflow passing therealong, when said electric vehicle is in motion.

3. The thermal management system of claim 1 wherein said at least one motor passively dissipates at least a portion of heat generated by said motor to an ambient airflow passing therealong, when said electric vehicle is in motion.

4. The thermal management system of claim 1 wherein said electric vehicle has a drag coefficient of at most about 0.13.

5. The thermal management system of claim 1, wherein said heat exchanger comprises a heat exchanger including a chamber including an inner chamber portion and an outer chamber portion, said inner chamber portion having an inlet and an outlet disposed proximate a first end, at least one indentation, a fluid channel, and a channel divider, said outer chamber portion forming a body panel of said electric vehicle, wherein in an assembled configuration, said inner and outer chamber portions form said chamber adapted to receive a fluid at said inlet, to expel said fluid at said outlet, said fluid passing along said fluid channel, said channel divider extending from said first end to proximate a second end, said channel divider providing a fluid separation within said chamber such that said fluid passes from said inlet, proximate said second end, and then through to said outlet, and wherein said at least one indentation is disposed along said fluid channel configured to promote turbulence of said fluid in said chamber.

6. A thermal management system for an electric vehicle comprising:
a drive flow path including one or more mechanical energy conversion devices consisting of one or more circulating pumps, at least one inverter, at least one motor, and at least one heat exchanger, said drive flow path adapted for coupling said flow regulating device, said at least one inverter, said at least one motor, and said at least one heat exchanger, said drive flow path further adapted for transferring heat from said inverter and said motor to said heat exchanger, said heat exchanger forming a body panel of said electric vehicle,
wherein said drive flow path is decoupled from a refrigerant flow path under all operational modes of said electric vehicle, and said refrigerant flow path is adapted for providing cooling to a cabin and/or a battery pack.

7. The thermal management system of claim 6 wherein said at least one motor is a direct-drive, in-wheel motor, each of said at least one motors being disposed proximate or within a wheel and disposed at least partially within a wheel housing, wherein said wheel housing is physically spaced away from a body of said electric vehicle so that said wheel housing is almost entirely surrounded by an ambient airflow passing therealong, when said electric vehicle is in motion.

8. The thermal management system of claim 7 wherein said at least one motor passively dissipates at least a portion of heat generated by the same to an ambient airflow passing therealong, when said electric vehicle is in motion.

9. The thermal management system of claim 8 wherein said electric vehicle has a drag coefficient of at most about 0.13.

10. The thermal management system of claim 9 wherein said heat exchanger includes a chamber including an inner chamber portion and an outer chamber portion, said inner chamber portion having an inlet and an outlet disposed proximate a first end, at least one indentation, a fluid channel, and a channel divider, wherein said heat exchanger forming a body panel of said electric vehicle comprises said outer chamber portion forming a body panel of said electric vehicle, wherein in an assembled configuration, said inner and outer chamber portions form said chamber adapted to receive a fluid at said inlet, to expel said fluid at said outlet, said fluid passing along said fluid channel, said channel divider extending from said first end to proximate a second end, said channel divider providing a fluid separation within said chamber such that said fluid passes from said inlet, proximate said second end, and then through to said outlet, and wherein said at least one indentation is disposed along said fluid channel configured to promote turbulence of said fluid in said chamber.

11. The thermal management system of claim 10, wherein at least about 50% to at least about 90% of the airflow passing over said heat exchanger is laminar airflow along an outer heat rejection surface of said outer chamber portion.

12. The thermal management system of claim 11, wherein at least about 50% to at least about 90% of the airflow passing over said heat exchanger remains attached along an outer heat rejection surface of said outer chamber portion.

13. An electric vehicle comprising:
a body including upper and lower body portions extending from a front end to a trailing end, said front end forming a tapered profile;
at least one heat exchanger comprising one or more body panels for the electric vehicle, each heat exchanger being disposed along said lower body portion, each heat exchanger further comprising:
a chamber including an inner chamber portion and an outer chamber portion, said inner chamber portion having an inlet and an outlet disposed proximate a first end, at least one indentation, a fluid channel, and a channel divider, said outer chamber portion forming a body panel of said body, wherein in an assembled configuration, said inner and outer chamber portions form said chamber adapted to receive a fluid at said inlet, to expel said fluid at said outlet, said fluid passing along said fluid channel, said channel divider extending from said first end to proximate a second end, said channel divider providing a fluid separation within said chamber such that said fluid passes from said inlet, proximate said second end, and then through to said outlet, and wherein said at least one indentation is disposed along said fluid channel configured to promote turbulence of said fluid in said chamber;
a thermal management system comprising:
a drive flow path including a flow regulating device, at least one inverter, at least one motor, and at least one heat exchanger, said drive flow path adapted for coupling said flow regulating device, said at least one inverter, said at least one motor, and said at least one heat exchanger, said drive flow path further adapted for transferring heat from said inverter and said motor to said at least one heat exchanger;
a refrigerant flow path including a compressor, a condenser, a cooling coil having a first expansion valve, and a chiller having a second expansion valve, said refrigerant flow path adapted for coupling said compressor, said condenser, said cooling coil, and said chiller to form a refrigeration cycle, said cooling coil adapted to cool a cabin, said chiller adapter to cool a battery pack; and
a heat rejection flow path including a heat rejection flow regulating device, said condenser, at least one heat exchanger, at least one supplemental heat exchanger having at least one fan and said battery pack, said heat rejection flow path adapted for coupling said heat rejection flow regulating device, said condenser, said at least one heat exchanger, at least one supplemental heat exchanger, and said battery pack,
wherein in a first operational mode, said heat rejection flow path transfers heat from said condenser to said heat exchanger coupled thereto and/or to said supplemental heat exchanger, and in a second operational mode, said heat rejection flow path transfers heat from said battery pack to said supplemental heat exchanger;
and wherein said drive flow path is decoupled from said refrigerant flow path under all operational modes of said electric vehicle.

14. The electric vehicle of claim 13, wherein each of said first and second expansion valves are selected from the group consisting of: a thermostatic expansion valve and/or an electronic expansion valve.

15. The electric vehicle of claim 13, wherein said at least one motor is a direct-drive, in-wheel motor, each of said at least one motors being disposed proximate or within a wheel and disposed at least partially within a wheel housing, wherein said wheel housing is physically spaced away from a body of said electric vehicle so that said wheel housing is almost entirely surrounded by an ambient airflow passing therealong, when said electric vehicle is in motion.

16. The electric vehicle of claim 15 wherein said at least one motor passively dissipates at least a portion of heat generated by the same to an ambient airflow passing therealong, when said electric vehicle is in motion.

17. The electric vehicle of claim 13 wherein said electric vehicle has a drag coefficient of at most about 0.13.

18. The electric vehicle of claim 13, wherein at least about 50% to at least about 90% of the airflow passing over said plurality of heat exchangers is laminar airflow along an outer heat rejection surface of said outer chamber portion.

19. The electric vehicle of claim 13, wherein at least about 50% to at least about 90% of the airflow passing over said plurality of heat exchangers remains attached along an outer heat rejection surface of said outer chamber portion.
